(19) United States
(12) Patent Application Publication
(10) Pub. No.: US 2012/0224373 A1
(43) Pub. Date: Sep. 6, 2012

(54) Modular lighting unit comprising a magnetic fastening arrangement

(75) Inventors: Pieter Jacob Snijder, Valkenswaard (NL); Pierre Robert Valère Sonneville, Weert (NL); Adrianus Sempel, Waalre (NL)

(73) Assignee: KONINKLIJKE PHILIPS ELECTRONICS, N.V., EINDHOVEN (NL)

(21) Appl. No.: 13/508,549

(22) PCT Filed: Nov. 5, 2010
(86) PCT No.: PCT/IB10/55029

§ 371 Date: May 8, 2012

(30) Foreign Application Priority Data
Nov. 13, 2009 (EP) 09175952.2

(51) Int. Cl. F21V 21/096

(52) U.S. Cl. 362/249.01

(57) ABSTRACT

The invention relates to a modular lighting unit (1) comprising a front side (2), a rear side (3) opposite to the front side (2), at least three edge sides (4a, 4b) surrounding the front side (2), light elements (5) disposed on at least the front side (2), and a magnetic fastening arrangement for attachment with a corresponding magnetic fastening arrangement on a neighboring lighting unit (1). The magnetic fastening arrangement comprises sets of magnets (7a, 7b) of different polarities. Since a pair of magnets may be connected to each other only if the polarities are opposite, the magnets of the modular lighting unit (1) are positioned and the polarities of the magnets (7a, 7b) are arranged, such that two adjacent edge sides (4a, 4b) of two similar neighboring lighting units (1) may be attached to each other only if the modular lighting unit (1) is correctly rotated, resulting in that correct alignment of the lighting units (1) is ensured. The magnets (7a, 7b) are covered by a contact spring (8) which is formed such that a lighting unit (1) may easily be inserted or removed from an existing array (15) of lighting units (1).

### FIELD OF THE INVENTION

The present invention relates generally to modular lighting and in particular to a magnetic fastening arrangement for a modular lighting unit.

### BACKGROUND OF THE INVENTION

Modular lighting refers to modular lighting units that can be assembled in order to obtain large lighting devices of various sizes and shapes. Each lighting unit has several light elements, e.g. RGB LEDs. In addition to the flexibility in adapting the size and shape of such modular lighting applications, e.g. to the available space where the modular lighting application is to be installed or due to other reasons, such modular lighting applications may be used to visualize lighting patterns, including still and moving images and light effects, on a screen that may have a size and a shape that in general deviates from standard rectangular liquid crystal display (LCD) devices. Particularly two-dimensional lighting units are typically referred to as lighting tiles, or simply tiles. Such a lighting tile may have various polygonal shapes, such as for example a square, triangle or pentagon shape. The lighting tiles are not limited to two-dimensional shapes but may have a three-dimensional shape, such as a cube or a pyramid. Fields of application for such modular lighting may for example be digital signage and atmosphere creation.

Since the shape and size of the lighting system can be modified by adding, removing and relocating lighting tiles, it is desired that the system is easy to mount, similarly to building blocks. Also, the user should be able to remove any tile without removing other tiles first, for instance for changing a non-working tile. Hence, there is a need of a mechanical interconnect system that enables easy and time-saving assembling. Further, it is convenient to provide a mechanical interconnect system that ensures correct alignment of the tiles, for instance in case of double-sided tiles.

US2005116667 discloses tiles equipped with a magnetic facility for holding tiles together by the attraction of magnets. However, the magnetic facility does not provide all of the desired features.

Hence, there is a need for an improved mechanical interconnect system for lighting tiles, and more specifically a mechanical interconnect system that overcomes or at least alleviates the prior art problems.

### SUMMARY OF THE INVENTION

It is an object of the present invention to overcome this problem, and to provide a modular lighting unit having a mechanical interconnect system that enables easy and time-saving assembling and ensures correct alignment of the lighting units.

According to a first aspect of the invention, this and other objects are achieved by a modular lighting unit comprising a front side, a rear side opposite to the front side, at least three edge sides surrounding the front side, light elements disposed on at least said front side, and a magnetic fastening arrangement for attachment with a corresponding magnetic fastening arrangement on a neighboring lighting unit. The magnetic fastening arrangement comprises a first set of magnets of different polarities, arranged on a first edge side and a second set of magnets of different polarities, arranged on a second edge side opposite to the first edge side, wherein the polarities and positions of the magnets in the first and second sets of magnets are such that the sets of magnets on two adjacent edge sides of two similar neighboring lighting units may be attached to each other in only one way, thereby ensuring correct alignment.

Here, the wording “a side opposite to another side” is intended to mean a side that may be intersected by a normal of the other side. Thus, for instance in case of a lighting unit with three edge sides, each of the sides has two opposite sides and opposite sides are also adjacent.

When mounting a number of such lighting units in a lateral or vertical row, the user does not have to worry about the alignment of the lighting units. Conventionally, the modular lighting units or tiles have been provided with a “this-side-up” sign at a rear side thereof. From a user-friendliness point of view the demand to have all tiles rotated properly is felt as cumbersome. This means that the user has to observe the sign at the rear side of the tile and rotate the tile correctly before adding the tile to the lateral or vertical row, which may be both time consuming and annoying. Lighting units comprising magnetic fastening arrangements according to the invention may be attached to each other without observing and paying attention to “this-side-up” signs or the like, since the magnetic fastening arrangement handles the alignment of the lighting units regarding rotation of the lighting unit in its plane, rotation of the lighting unit around an axis intersecting the plane of the lighting unit, as well as translation movement of the lighting unit in its plane. The magnets of two adjacent lighting units may be brought in direct contact with each other only if the polarities of each pair of adjacent magnets are opposite. Thus, due to the arrangement of the polarities of the magnets, two adjacent edge sides of two neighboring lighting units may be attached to each other in only one way for enabling the magnetic fastening arrangements to function successfully, that is, such that the neighboring lighting units are held together by the magnets. Hence, each lighting unit have to be correctly rotated in relation to a neighboring lighting unit regarding its front and rear sides. Such positions of the magnets on two opposite edge sides results in that two adjacent lighting units are automatically correctly aligned in a longitudinal direction of the row. That is, an edge side of a first lighting unit, which comprises magnets, extends along an entire edge side of a neighboring second lighting unit, which also comprises magnets. Thus, the edge sides of the lighting units not comprising magnets form a smooth and flat edge side of the row.

Such magnetic fastening arrangement may be used for ensuring that electrical contacts between lighting units are correctly connected for ensuring that the row of lighting units is not short-circuited. That is, the electrical contacts may be arranged in a suitable way such that when the magnetic fastening arrangements function successfully the electrical contacts are correctly connected. In addition, communication units for communication between the lighting units may also be arranged similarly. Thus, the magnetic fastening arrangement provides the lighting units with a fail-safe fastening arrangement, which ensures that neighboring lighting units are correctly aligned and connected to each other.

Further, such a magnetic fastening arrangement results in a system that is easy to mount and enables the user to build a row of modular lighting units similarly to building blocks. Also, the user is able to remove any tile without removing other tiles first, for instance for changing a non-working tile.

According to an exemplary embodiment, the lighting unit comprises four edge sides. Rectangular lighting units are easier to mount than for instance triangular ones, since rectangular lighting units do not need support before a, in a lateral direction, neighboring lighting unit is added. In case of triangular lighting units every second lighting unit has to be mounted with its tip downwards, thus, such a lighting unit may need to be supported before its neighboring lighting unit is mounted.

According to an exemplary embodiment, the modular lighting unit further comprises a third and fourth set of magnets of different polarities, wherein said third and fourth sets each are arranged on two remaining edge sides of the lighting unit.

The magnets may be arranged such that the polarities and positions of the magnets of the third and fourth sets are such that the sets of magnets on two adjacent edge sides of two similar neighboring lighting units may be attached to each other in only one way, whereby correct alignment is ensured. However, the magnets may be arranged either such that two arbitrary edge sides of two neighboring lighting units may be attached to each other, or such that only every second edge side of the two neighboring lighting units may be attached to each other. Alternatively, there may be only one edge side on a neighboring tile which matches only one of the edge sides on another neighboring tile.

Such a lighting unit may not only have two neighboring lighting units attached to two edge sides which are opposite to each other, but also two neighboring lighting units attached to the two remaining edge sides. Thus, such a lighting unit may not only be mounted in a row with two adjacent lighting units, but also in two dimensional arrays with four or more adjacent lighting units. When mounting a number of such lighting units in two dimensional arrays, the user does not have to worry about the alignment of the lighting units, due to the arrangement of the polarities of the magnets, the lighting units are correctly aligned if the magnetic fastening arrangements function successfully, similarly to the lighting units having sets of magnets on only two edge sides. In this case, each edge side of the neighboring lighting units, which is adjacent to one of the four edge sides of a central lighting unit, is aligned when the lighting units are mounted together. That is, two adjacent edge sides of different neighboring lighting units are arranged edge to edge. Thus, both vertical and horizontal rows in a two dimensional array are aligned in their longitudinal directions.

Further, such a magnetic fastening arrangement results in a system that is easy to mount and enables the user to build a two dimensional array of modular lighting units similarly to building blocks. Also, since the lighting units are aligned in rows as well as since the magnetic fastening arrangement allows for easy disconnection of two neighboring lighting units, the user is able to remove any tile without removing other tiles first, for instance for changing a non-working tile.

Such magnetic fastening arrangement may be used for ensuring that electrical contacts between lighting units are correctly connected for ensuring that the array of lighting units is not short-circuited. That is, the electrical contacts may be arranged in a suitable way such that when the magnetic fastening arrangements function successfully the electrical contacts are correctly connected. In addition, communication units for communication between the lighting units may also be arranged similarly. Thus, the magnetic fastening arrangement may provide the lighting units with a fail-safe fastening arrangement, which also ensures that neighboring lighting units are correctly connected to each other.

According to an exemplary embodiment, the magnets on two oppositely located edge sides are arranged, with respect to their positions, in mirror symmetry with respect to an axis of symmetry which intersects an edge side located between said edge sides. Such oppositely positioned magnets on opposite edge sides results in that two adjacent lighting units are automatically correctly aligned in a longitudinal direction of the row or two dimensional array. That is, an edge side of a first lighting unit, which comprises magnets, extends along an entire edge side of a neighboring second lighting unit, which also comprises magnets. Thus, the edge sides of the lighting units not comprising magnets form a smooth and flat edge side of the row or two dimensional array.

According to an exemplary embodiment, wherein the magnets on two oppositely located edge sides are arranged, with respect to their polarities and positions, in mirror symmetry with respect to an axis of symmetry which intersects an edge side located between said edge sides.

The user has to rotate such a lighting unit correctly in order to be able to mount the lighting unit to a neighboring one, since such an arrangement avoids successful attachment of a modular lighting unit after an erroneous rotation in its plane and. On the contrary, such a lighting unit having only two sets of magnets may be rotated such that a rear side is facing a front side of an array, without affecting the function of the magnetic fastening arrangement.

According to an exemplary embodiment, wherein said magnets are arranged, with respect to their polarities and positions, in 2-fold rotational symmetry in the plane of the modular lighting unit.

When mounting a number of such lighting units together, such a lighting unit may be rotated half turns in the plane of the lighting unit. That is, the lighting unit may be mounted to a neighboring one using two of the edge sides which are opposite to each other. The user may not rotate the lighting unit about an axis intersecting the plane of the lighting unit, such that a rear side of the lighting unit is facing the front side of the array of the lighting units, since such a rotation leads to that the magnetic fastening arrangements should avoid successful attachment. Hence, if the magnetic fastening arrangements function successfully the lighting units are mounted such that all front sides are facing the same side of the two dimensional array of the lighting units, and correct alignment is ensured. Consequently, the user does not have to worry about rotating the lighting units wrongly. Also in this case the electrical contacts and communication units are arranged such that correct alignment of the lighting units ensures that both are correctly connected.

According to an exemplary embodiment, said magnets are arranged, with respect to their polarities and positions, in 4-fold rotational symmetry in the plane of the modular lighting unit.

When mounting a number of such lighting units together, such a lighting unit which is 4-fold rotational symmetrical in its plane when it comes to both polarities and positions of the magnets, may be rotated quarter turns in the plane of the modular lighting unit in relation to a neighboring lighting unit. That is each lighting unit may be attached to a neighboring lighting unit using either one of the edge sides. However, the user may not rotate the lighting unit such that a rear side is facing the front side of the array of the lighting units, since such a rotation avoids successful function of the magnetic fastening arrangement. Hence, if the magnetic fastening arrangements function successfully the lighting units are mounted with right sides front and back, respectively, and correct alignment is ensured. In addition, since arbitrary edge sides of neighboring lighting units may face each other, the user does not have to consider such orientation of each lighting unit or worry about rotating the lighting units wrongly at the same time as the rear and front sides are correctly orientated. Also in this case the electrical contacts and communication units are arranged such that correct alignment of the lighting units ensures that both are correctly connected.

According to an exemplary embodiment, the relative position of the magnets on two oppositely located edge sides is different compared to the relative position of the magnets on the remaining edge sides.

Such different positions of the magnets of the third and fourth sets allows such a lighting unit to be rotated only half turns in the plane of the modular lighting unit. However, such lighting units may not be rotated quarter turns in the plane of the modular lighting unit. It may be advantageous in some applications.

According to an exemplary embodiment, the magnets of said first and second sets are both positioned in one end of respective side edge. Such positions of magnets of the first and second sets allows for such a lighting unit to be rotated only half turns in the plane of the modular lighting unit, which may be advantageous in some applications.

According to an exemplary embodiment, each magnet is covered with an electrically well-conducting spring, to provide electrical interconnect between the modular lighting units. Such a design is useful, since it combines both mechanical and electrical interconnect into one component.

According to an exemplary embodiment, the modular lighting unit comprises light elements disposed on said rear side of the modular lighting unit. Such a lighting unit enables the user to build, for instance, two dimensional arrays or walls which emit light or may show patterns or video at both sides.

It is noted that the invention relates to all possible combinations of features recited in the claims.

### BRIEF DESCRIPTION OF THE DRAWINGS

This and other aspects of the present invention will now be described in more detail, with reference to the appended drawings showing embodiment(s) of the invention, in which:

FIG. 1 is a schematic illustration of a preferred embodiment of a lighting unit according to the invention;

FIG. 2 is a schematic illustration of a combined mechanical and power interconnect component according to the an aspect of the invention;

FIG. 3 is a schematic illustration of an array of lighting units, a controller interface and an external controller; and

FIGS. 4a-4f are schematic illustrations of other embodiments of a lighting unit according to the invention.

### DETAILED DESCRIPTION OF EMBODIMENTS

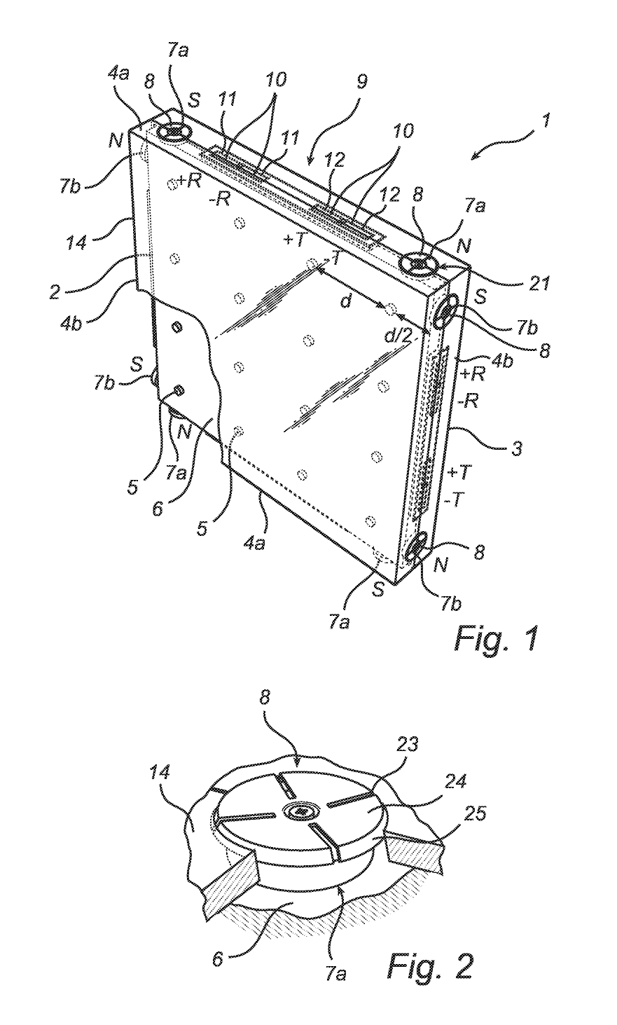

The invention will now be described with reference to the modular lighting unit or tile 1 in FIG. 1, which is square shaped and comprises a front side 2, a rear side 3, and four edge sides 4a, 4b surrounding the front and rear sides 2, 3. The tile 1 is double-sided, that is, both the front and rear side 2, 3 comprises a plurality of light elements 5. In the illustrated example, each side has 16 light elements 5 symmetrically spread across the tile 1 in four rows and four columns. The shortest distance, d, between two adjacent light elements 5 on one single tile 1 is twice as long as the distance, d/2, along an imaginary perpendicular line to an adjacent light element 5 from an edge side 4a, 4b. For instance, the light elements 5 may be LEDs. The exemplary double-sided tile 1 is formed by mounting light elements 5 on both sides of a carrier 6, which may comprise a printed circuit board, a foil, or a combination of the two. However, a double-sided tile 1 may also be formed by assembling two single-sided carriers back-to-back. Within the scope of the claims, the tile 1 does not have to be double-sided, but may also be single-sided, that is, the tile 1 comprises light elements 5 only on one of the front and rear sides 2, 3.

Each edge side 4a, 4b of the tile 1 comprises a set of magnets 7a, 7b of different polarities, which together form a magnetic fastening arrangement. The magnets 7a; 7b of two opposite edge sides 4a; 4b are oppositely positioned and each of the magnets 7a, 7b is positioned near the ends of the edge sides 4a, 4b. However, within the scope of the invention the magnets 7a, 7b may be positioned differently. The magnets 7a, 7b are arranged in 4-fold rotational symmetry, with respect to their polarities, in the plane of the tile 1. The polarities of the magnets 7a, 7b are indicated with N and S in all figures. When mounting a number of tiles 1 together to an one or two dimensional array, such an arrangement of polarities enables rotation of the tile 1 in the plane of the tile 1, that is, the tile 1 may be attached to a similar neighboring tile 1 regardless of which of the edge sides 4a, 4b is facing an edge side 4a, 4b of a neighboring tile 1. However, the tile 1 according to the embodiment in FIG. 1 may not be rotated such that a front side 2 is facing a back side of an array of tiles 1, since in such a case the magnetic fastening arrangement avoids successful attachment.

The magnets 7a, 7b are disc shaped and covered with a contact spring comprising metal, here in the form of a metal washer 8. Thus, both mechanical and power interconnect are combined into one component 21. The magnets 7a, 7b and washers 8 may have a different shape than circular, such as rectangular or another polygonal shape. However, a circular shape is advantageous, since such a form facilitates to make the tile 1 water-proof by means of for instance a rubber sealing. Such a water-proof tile is preferable in damp environments, such as outdoors or in bathrooms or the like.

The magnets 7a, 7b comprise neodymium iron boron (NdFeB). Since NdFeB is sensitive to humidity, the magnets 7a, 7b may be covered by a sheet of nickel for use in damp environments. For protecting the nickel sheet from forming holes due to sparking, which holes may result in that the magnets 7a,7b are exposed to humidity, the washer 8 consist of a well-conducting and low-sparking metal, such as phosphor bronze or any other suitable contact material, which may be gold-plated. Phosphor bronze is advantageous since it also has good spring properties.

Internal power interconnect of the tiles is arranged in a suitable way such that desired rotation of the tile is enabled without short-circuiting an array of tiles. Examples of such circuitry is disclosed in WO2007/069130, but not described in detail here. Since the tile 1 is double-sided and comprises only one carrier 6, electronic circuitry, such as a processor integrated circuit, may not be arranged on one of the sides of the carrier 6. Instead, the electronic circuitry is arranged on the carrier together with the light elements 5.

Each edge side 4a, 4b of the tile 1 comprises a communication unit, for communication of lighting data. The communication units, which are wireless serial data ports 9, are centered on the edge sides 4a, 4b and each data port 9 comprises four copper fields 10. The copper fields 10 of two opposite edge sides 4a, 4b are oppositely positioned. The copper fields 10 form pair wise one side of a differential capacitive coupling, so that two adjacent copper fields closest to an end of the edge side 4a, 4b form a differential receive input 11, denoted with a R in FIG. 1, and the two remaining copper fields form a differential transmit output 12, denoted with a T in FIG. 1. The differential receive inputs 11 and the differential transmit outputs 12 are arranged in 4-fold rotational symmetry, with respect to their polarities, regarding the plane of the tile 1. The polarities are indicated with plus and minus signs in the figures. The copper fields 10 are adapted to be at a suitable distance from their counterparts residing on one similar neighboring tile 1, that is mounted adjacent to the tile 1, such that capacitive coupling is enabled. Alternatively, the polarities of the differential receive inputs 11 and the differential transmit outputs 12 may be interchanged or the data ports 9 may be positioned in some other suitable way, such as adjacent to one end of the edge side 4a, 4b. According to an alternative embodiment, only two opposite edge sides 4a; 4b of the tile 1 comprises data ports 9.

Alternatively, the copper fields may be replaced by any electrically conductive layer, even a carbon layer. Still alternatively, the communication units may use inductive coupling or optical coupling instead of capacitive coupling.

The lighting tile 1 may comprise a transparent cover 14 that at least partly encloses the carrier 6. Such a transparent cover 14 protects the light elements 5 against for instance lateral impacts at the same time as it enables visual access to the light elements 5, and may make the front and rear sides 2, 3 of the tile 1 water-proof. In addition, the cover 14 may comprise some type of optical filter on the side facing the carrier 6. Such a filter provides means for optical effects which are difficult to achieve otherwise, such as electronically. The cover 14 has through recesses intended for the magnets 7a, 7b and the washers 8. The data ports 9 are enclosed by the transparent cover 14. Alternatively, the edge sides of the cover 14 may be non-transparent.

According to an alternative embodiment, only two opposite edge sides 4a; 4b of the tile 1 comprises magnets 7a; 7b and data ports 9. In such a case, the magnets 7a; 7b and data ports 9 are arranged as described above, which results in that they are in 2-fold rotational symmetry with respect to the plane of the tile 1. In other aspects such an embodiment is similar to the embodiment in FIG. 1. Such a tile 1 may be mounted so that a two-dimensional, vertical or horizontal, array 15 is formed, which may be preferable in some applications.

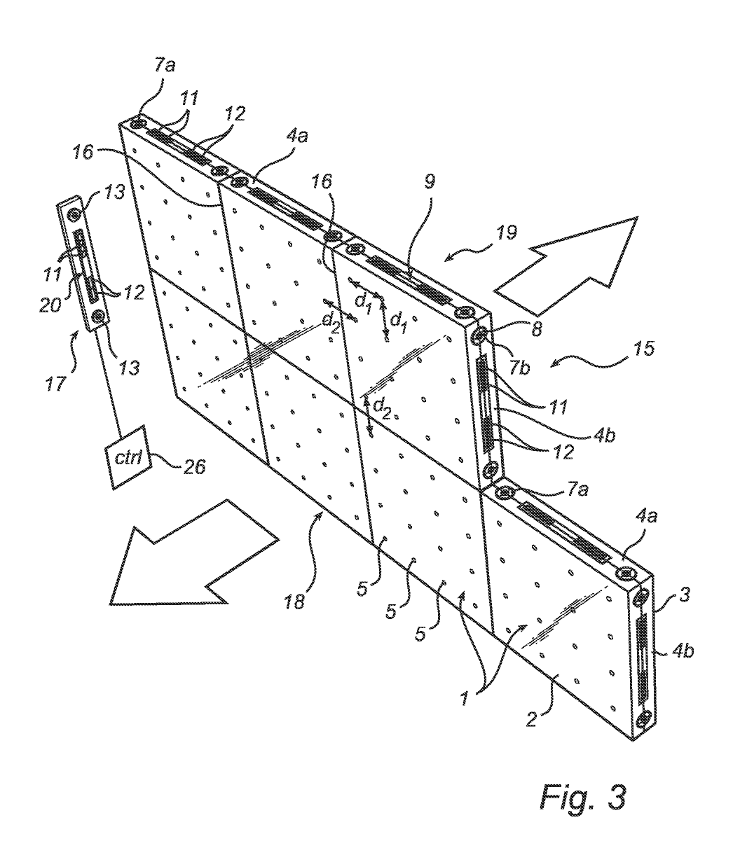

FIG. 2 shows the combined mechanical and power interconnect component 21 in more detail. The magnets 7a, 7b and washers 8 are mounted to the carrier 6 by means of suitable fastener such as a screw. The washer here has a conical shape, so that the peripheral part of the washer 8 is slightly farther away from the centre of the magnets 7a, 7b than the centre of the washer 8. A washer with this shape provides a spring action, and ensures satisfactory electrical contact between two magnets when they are pressed together by magnetic force.

The peripheral part of the washer 8 may be bent towards the magnet 7a, 7b such that an outer peripheral edge 25 is beneath a surface of the surrounding structure. The surrounding structure is in this embodiment the cover 14 and the wording beneath is intended to mean closer to the centre of the tile 1 regardless of if it actually is above the surface or in a horizontal direction from the surface. Such a design ensures that, when inserting a tile 1 into or removing a tile 1 from an existing array of tiles, the washers 8 of two adjacent edge sides 4a, 4b may not engage with each other. That is, due to both that the peripheral part of the washer 8 is bent towards the magnets 7a,7b and that the peripheral edge 25 is beneath the surface of the edge sides of the cover 14, a washer 8 is prevented from being stuck between the magnet 7a, 7b and the washer 8 on an adjacent tile 1.

In the illustrated his embodiment, the washer 8 comprises four incisions 23, extending from the circumference of the washer towards a centre of the washer such that four wing like parts 24 are formed. The number of incisions 23 may be arbitrary. By dividing the washer into four wings 24, the spring constant is reduced to allow the magnetic force to overcome the spring action.

The cover is arranged such that the washers 8 may be pressed towards the magnets such that the surface of the washer 8 and the surface of the cover 14 are aligned. Hence, the adjacent edge sides 4a, 4b of two adjacent tiles 1 are arranged edge to edge at the same time as good electrical contact between the tiles 1 is ensured.

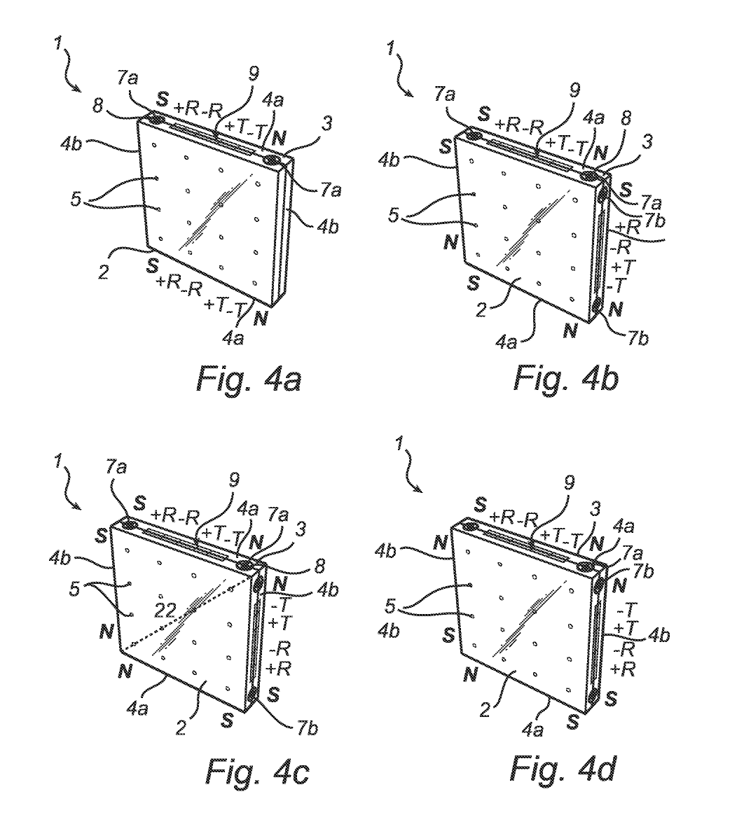

FIG. 3 shows an array 15 of tiles 1 according to the embodiment in FIG. 1, which tiles 1 are arranged together using the magnetic fastening arrangement described above. The tiles 1 may be assembled together to an array 15, similarly to building blocks, by bringing together two tiles 1 so that the magnets 7a, 7b on two adjacent edge sides 4a, 4b of the tiles 1 are in direct contact with each other. Since the magnets 7a, 7b may be brought in direct contact with each other only if the polarities of each pair of adjacent magnets 7a, 7b are opposite, the tiles 1 has to be correctly rotated regarding the front and rear sides 2, 3. That is, in case of tiles 1 according to the exemplary embodiment in FIG. 1, the tiles have to have all the front sides 2 facing the same side of the array 15. Thus, if it is possible to bring the magnets 7a, 7b of two tiles 1 in direct contact with each other, a correct alignment of the tiles 1 is ensured and the user does not have to worry about the alignment of the tiles 1. In addition, since the magnets 7a; 7b of two opposite edge sides 4a; 4b are oppositely positioned, the tiles 1 are automatically correctly aligned vertically and horizontally with respect to neighboring tiles 1. That is, two adjacent edge sides 4a, 4b of two adjacent tiles 1 are arranged edge to edge.

Since the data ports 9 are arranged in relation to the magnets 7a, 7b as described above, the correct alignment of the tiles 1 ensures that the data ports 9 on the two adjacent edge sides 4a, 4b of the tiles 1 match and may function as is intended. Even though it is not possible to flip a front side 2 back or vice versa, a tile 1 may be rotated in its plane since the magnets 7a, 7b and the data ports 9 are arranged in 4-fold rotational symmetry regarding the plane of the tile 1. Hence, the user does not have to worry about the tile 1 being correctly rotated in its plane for matching another neighboring tile 1, if the power interconnect is also arranged in 4-fold rotational symmetry. Consequently, due to the 4-fold rotational symmetry of the magnets, a tile 1 may be rotated arbitrarily in the plane of the tile, but the user may not rotate the tile 1 front to back, since such a rotation puts the magnetic fastening arrangement out of action. Hence, if the magnetic fastening arrangements function successfully the tiles 1 are mounted with the front side 2 facing the front side 18 of the array 15 and the rear side 3 facing the rear side 19 of the array 15, and correct alignment is ensured. In addition, such magnetic fastening arrangement simplifies the mounting of the tiles 1, since the user does not have to worry about the alignment or rotation of the tiles 1.

The shape and size of the array 15 may be modified by adding, removing and relocating tiles 1. Also, the user is able to remove any tile 1 without removing other tiles 1 first, for instance for changing a non-working tile 1, by pushing one of the tiles 1 on its front or rear side 2, 3 so that a force that is substantially at right angles to the front or rear side 2, 3 is applied to the tile 1.

The FIG. 3 shows also an external controller 26, and a controller interface 17, which is used for applying power and lighting data to the total array 15 of tiles 1. The controller interface 17 comprises one set of magnets 13 matching the sets of magnets 7a, 7b on the lighting tiles 1 and may be attached to an arbitrary tile 1 by use of the magnets 7a, 7b, 13. The controller interface 17 comprises also one communication unit 20 matching the communication unit 9 on the lighting tiles 1. Thus, the communication unit 20 of the controller interface 17 may also be a wireless serial data port comprising one differential receive input 11 and one differential transmit output 12. The controller interface 17 supplies required power and data to the whole array 15 of tiles 1 and is applied to one single tile 1, which has at least one edge side 4a, 4b located along the outline of the array 15. However, very large arrays may need multiple power or data sources, that is, multiple controller interfaces 17. The controller interface 17 may be coupled to the external controller 26 using a cable.

Lighting data within the array 15 are distributed via the tiles themselves using the data ports 9 located on the edge sides 4a, 4b of the tiles 1. Thus, all tiles 1 of the array 15 forms a data network which takes care of distributing lighting and control data applied to one tile 1. In addition, the network allows for high-rate data communication between the tiles 1. In the exemplary embodiment described above the data ports 9 comprises a full-duplex differential capacitive coupling, which enables high-bandwidth serial two-way communication between all adjacent edge sides 4a, 4b of adjacent tiles 1 in an array 15.

The distance, d₁, between two adjacent light elements 5 in same row or column of one tile 1 equals the distance, d₂, between two adjacent light elements 5 in same row or column of two adjacent tiles 1 regardless of tile boundaries 16. Since lighting data is distributed via the wireless serial data ports 9, which are enclosed in the edge sides of the cover 14 of the tiles 1, and since the surfaces of the combined electrical power and mechanical interconnect components 21, that is, the magnets 7a, 7b and the springs 8, are arranged edge to edge with the surfaces of the edge sides of the transparent cover 14, the entire area of the front and rear sides 2, 3 may comprise light elements 5. Thus, when arranging several tiles 1 to an array 15, when the tiles are powered a double-sided illuminated tiled area is created, which area has virtually invisible tile boundaries 16. The arrows in the FIG. 3 illustrate that light is emitted on both sides of the array 15.

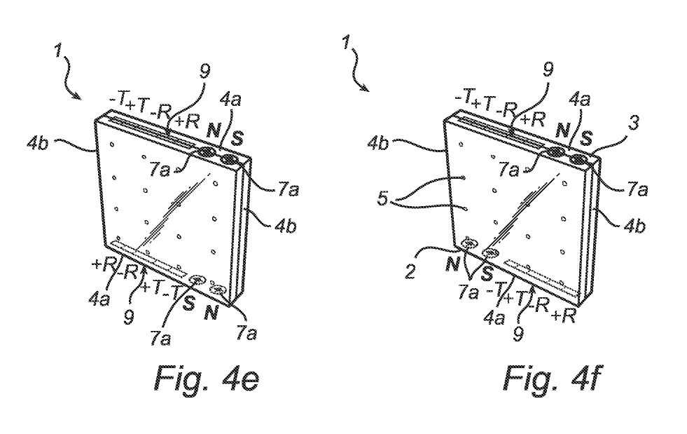

FIGS. 4a-4f illustrate exemplary embodiments having different magnetic fastening arrangements. The polarities of the magnets 7a, 7b are indicated with N and S in the figures. The different magnetic fastening arrangements described below in relation to FIGS. 4a-4f enable somewhat different rotation of the tiles compared to each other and to the embodiment illustrated in FIG. 1.

In FIG. 4a only two opposite edge sides 4a of the tile 1 comprises magnets 7a of different polarities, which are arranged, with respect to their polarities and positions, in mirror symmetry with respect to an axis of symmetry which intersects an edge side 4b located between said opposite edge sides 4a. Only the edge sides 4a comprising magnets 7a comprises spring contacts 8 and wireless serial data ports 9. The differential receive inputs 11 and the differential transmit outputs 12 of the data ports 9 are arranged, with respect to their polarities, in mirror symmetry with respect to an axis of symmetry which intersects an edge side 4b located between said opposite edge sides 4a. In other aspects the embodiment in FIG. 4a is similar to the embodiment in FIG. 1. Such a tile 1 may be mounted so that a two-dimensional, vertical or horizontal, array 15 is formed, which may be preferable in some applications. When mounting a number of such tiles 1 together each tile 1 has to be correctly orientated in relation to the orientation of the neighboring tile 1, in the plane of the tile, in order to be able to mount the tile 1 to a neighboring one. The magnetic fastening arrangement according to the embodiment should avoid successful attachment of a tile 1 after an erroneous rotation in its plane. On the contrary, once the tile 1 is correctly orientated, such a tile 1 may be rotated such that its rear side 3 is facing a front side 18 of an array 15 or vice versa, without affecting the function of the magnetic fastening arrangement. The internal power interconnect of the tile 1 is arranged in a suitable way, which allows the tile 1 to be rotated as described above.

In FIG. 4b the magnets 7a on two opposite edge sides 4a, are arranged, with respect to their polarities and positions, in mirror symmetry with respect to an axis of symmetry which intersects an edge side 4b located between said opposite edge sides 4a. The magnets 7b on two remaining edge sides 4b, are arranged with respect to their polarities and positions, in mirror symmetry with respect to an axis of symmetry which intersects an edge side 4a located between said opposite edge sides 4b. Also, the differential receive inputs 11 and the differential transmit outputs 12 of the data ports 9 are arranged such that the tiles may be rotated in the ways allowed by the magnets 7a, 7b. In other aspects the embodiment in FIG. 4b is similar to the embodiment in FIG. 4a.

According to another exemplary embodiment illustrated in FIG. 4c, two opposite edge sides 4a of the tile 1 comprises two sets of magnets 7a which are arranged, with respect to their polarities and positions, in 2-fold rotational symmetry. The two remaining edge sides 4b of the tile 1 comprises two sets of magnets 7b which are also arranged, with respect to their polarities and positions, in 2-fold rotational symmetry with regard to the plane of the tile 1. Thus, all the magnets 7a, 7b are in 2-fold rotational symmetry with regard to the plane of the tile 1 or in mirror symmetry with regard to an arbitrary diagonal, 22, of the tile 1. Such an arrangement of the magnets 7a, 7b allows for rotating a tile 1, in relation to the orientation of the neighboring tile 1, half turns in the plane of the tile 1, but does not permit rotation a quarter turn. It may be advantageous in some applications, for instance if the internal power interconnect is arranged in a way which enables only such rotation. Also, the differential receive inputs 11 and the differential transmit outputs 12 of the data ports 9 are arranged such that the tiles may be rotated in the ways allowed by the magnets 7a, 7b. In other aspects the embodiment in FIG. 4c is similar to the embodiment in FIG. 1.

According to another exemplary embodiment illustrated in FIG. 4d, two opposite edge sides 4b of the tile 1 comprises magnets 7b which are arranged, with respect to their polarities and positions, in mirror symmetry with respect to an axis of symmetry, which intersects an edge side located between the opposite edge sides 4a. The two remaining edge sides 4a of the tile 1 comprises magnets 7a which are arranged, with respect to their polarities and positions, in 2-fold rotational symmetry in the plane of the tile 1. Also, the internal tile power interconnect as well as the differential receive inputs 11 and the differential transmit outputs 12 of the data ports 9 are arranged such that the tiles may be rotated in the ways allowed by the magnets 7a, 7b. In other aspects the embodiment in FIG. 4d is similar to the other embodiments described above.

In still alternative embodiments, the magnets 7a disposed on two opposite edge sides 4a may be positioned differently in relation to each other than the magnets 7a, 7b of the embodiments in FIGS. 4a-4d. In FIGS. 4e and 4f two such embodiments are illustrated, which have magnets 7a on only two opposite edge sides 4a. In FIG. 4e the magnets 7a are oppositely positioned in one end of each edge side 4a. The polarities of the magnets are in 2-fold rotational symmetry. In such case, the data ports 9 on edge sides 4a comprising magnets 7a arranged at an end of the edge side 4a are positioned in some suitable way. The two remaining edge sides 4b do not comprise magnets 7b.

In FIG. 4f the magnets 7a are arranged, regarding their positions, in 2-fold rotational symmetry in the plane of the tiles 1. The magnets 7a on one edge side 4a are positioned in one end of the edge side 4a, while the magnets 7a on an opposite edge side 4a are positioned in the opposite end of the edge side 4a. The magnets 7a are arranged such that their polarities are not in 2-fold rotational symmetry. In such case, the data ports 9 on edge sides 4a comprising magnets 7a are positioned in some suitable way. The two remaining edge sides 4b do not comprise magnets 7b.

The tiles 1 according to each exemplary embodiment in FIG. 4e or 4f may be attached to each other successfully in only one way. When mounting a number of tiles 1 according to the embodiment in FIG. 4e together each of the tiles 1 has to be correctly orientated, regarding the rear and front sides 2, 3, in relation to the orientation of the neighboring tile 1, in order to be able to mount the tile 1 to a neighboring one. Thus in case of tiles 1 according to the embodiment in FIG. 4e, the tiles 1 has to be rotated such that all the rear sides 3 of the tiles 1 are facing the same side of the array 15. Also, since the tiles 1 has to be mounted such that the magnets 7a on two adjacent edge sides 4a of different tiles 1 are facing each other, each tile 1 has to be correctly rotated in its plane.

Also, when mounting a number of tiles 1 according to the embodiment in FIG. 4f together each of the tiles 1 has to be correctly orientated, regarding the rear and front sides 2, 3, in relation to the orientation of the neighboring tile 1, in order to be able to mount the tile 1 to a neighboring one. In this case, the tiles 1 has to be alternately rotated such that every second tile 1 has its front side 2 facing one side of the array 15, while the other tiles has their rear sides 3 facing the same side of the array 15. Also, since the tiles 1 has to be mounted such that the magnets 7a on two adjacent edge sides 4a of different tiles are facing each other, each tile 1 has to be correctly rotated in its plane. Consequently, one single tile 1 in an array 15 of the tiles 1 according to the exemplary embodiments in FIGS. 4e and 4f, may be attached to the neighboring tile 1 only in one way and may not be rotated at all, which may be advantageous in some applications.

Alternatively, the embodiments according to the FIGS. 4e and 4f may be combined with arbitrary positioned magnets 7b on the remaining edge sides 4b.

Still alternatively, the magnets 7a of two opposite edge sides 4a, may be centered on each edge side 4a, while the magnets 7b on the two remaining opposite edge sides 4b may be positioned as in the embodiment illustrated in FIG. 1, that is, each of the magnets 7b are positioned near the ends of the edge sides 4b. In such case, the data ports 9 on edge sides 4a comprising magnets 7a are positioned in some suitable way. Also, the internal tile power interconnect is arranged suitably such that the tile 1 may be rotated as is enabled by the arrangement of the magnets. Such arrangement of the magnets 7a, 7b at different positions permits the tiles 1 to be rotated only half turns in the plane of the tile 1, which may be advantageous in some applications, since the magnets 7a, 7b are arranged in 2-fold rotational symmetry regarding the positions of the magnets. Such a 2-fold rotational symmetrical arrangement of the positions of the magnets 7a, 7b may be combined with a 2-fold rotational symmetrical arrangement of the polarities in the plane of the tiles, for indicating for the user how to attach the tiles 1 together for enabling the magnetic fastening means to function successfully. Such an indication may fasten the mounting of the tiles together and decrease frustration of the user while mounting the system.

Within the scope of the invention the magnets 7a, 7b may be positioned in other suitable ways on the edge sides 4a, 4b as far as the intended purpose of the magnets 7a, 7b is fulfilled and the data ports 9 may be arranged such that the intended purpose of the magnets 7a, 7b is fulfilled.

In alternative embodiment, the magnets 7a, 7b are positioned only on two adjacent edge sides 4a, 4b of the tiles 1 and are arranged according to any one of the possibilities described above both regarding their positions on the edge sides 4a, 4b and their polarities. The two remaining edge sides 4a, 4b do not comprise magnets 7a, 7b. In such a case the data ports 9 are positioned on the same edges sides 4a, 4b as the magnets 7a, 7b. In still another embodiment, a square shaped tile 1 comprises magnets 7a, 7b on three of the edge sides 4a, 4b, but not on the remaining edge side 4a, 4b. The magnets 7a, 7b are arranged according to any one of the possibilities described above both regarding their positions on the edge sides 4a, 4b and their polarities. Also, in such a case the data ports 9 are positioned on the same edges sides 4a, 4b as the magnets 7a, 7b. In case of tiles 1 having other polygonal shape with more than four edge sides 4a, 4b, the magnets may be positioned similarly on an arbitrary number of edge sides 4a, 4b, which may also be adjacent.

The invention is not limited to sets of magnets 7a, 7b each comprising two magnets, each of the sets of magnets 7a, 7b may also comprise fewer or more magnets as long as they are arranged such that the intended purpose of the magnetic fastening arrangement is achieved.

Even though the tile 1 in FIG. 1 is square shaped, the invention is not limited to such a shape. The tiles 1 may have a rectangular shape or various polygonal shapes, such as triangle or pentagon shape. Further, the invention is not only limited to two-dimensional shapes, but may also have a three-dimensional shape, such as a cube or a pyramid.

Even though the invention has been described with reference to specific exemplifying embodiments thereof, many different alterations, modifications and the like will become apparent for those skilled in the art. For example, additionally, variations to the disclosed embodiments can be understood and effected by the skilled addressee in practicing the claimed invention, from a study of the drawings, the disclosure, and the appended claims. In the claims, the word “comprising” does not exclude other elements or steps, and the indefinite article “a” or “an” does not exclude a plurality. A single unit may fulfill the functions of several items recited in the claims. The mere fact that certain measures are recited in mutually different dependent claims does not indicate that a combination of these measured cannot be used to advantage.

1. A modular lighting unit comprising a front side, a rear side opposite to the front side, at least three edge sides surrounding the front side, light elements disposed on at least said front side, and a magnetic fastening arrangement for attachment with a corresponding magnetic fastening arrangement on a neighboring lighting unit, characterized in that the magnetic fastening arrangement comprises a first set of magnets of different polarities, arranged on a first edge side and a second set of magnets of different polarities, arranged on a second edge side opposite to the first edge side, wherein the polarities and positions of the magnets in the first and second sets of magnets are such that the sets of magnets on two adjacent edge sides of two similar neighboring lighting units may be attached to each other in only one way, thereby ensuring correct alignment.

2. The modular lighting unit according to claim 1, wherein said lighting unit comprises four edge sides.

3. The modular lighting unit according to claim 2, further comprising a third and fourth set of magnets of different polarities, wherein said third and fourth sets each are arranged on two remaining edge sides of the lighting unit.

4. The modular lighting unit according to claim 2, wherein the magnets on two oppositely located edge sides are arranged, with respect to their positions, in mirror symmetry with respect to an axis of symmetry which intersects an edge side located between said edge sides.

5. The modular lighting unit according to claim 2, wherein the magnets on two oppositely located edge sides are arranged, with respect to their polarities and positions, in mirror symmetry with respect to an axis of symmetry which intersects an edge side located between said edge sides.

6. The modular lighting unit according to claim 2, wherein said magnets are arranged, with respect to their polarities and positions, in 2-fold rotational symmetry in the plane of the modular lighting unit.

7. The modular lighting unit according to claim 2, wherein said magnets are arranged, with respect to their polarities and positions, in 4-fold rotational symmetry in the plane of the modular lighting unit.

8. The modular lighting unit according to claim 3, wherein the relative position of the magnets on two oppositely located edge sides is different compared to the relative position of the magnets on the remaining edge sides.

9. The modular lighting unit according to claim 3, wherein the magnets of said first and second sets are both positioned in one end of respective edge side.

10. The modular lighting unit according to claim 3, wherein each magnet is covered with an electrically well-conducting spring, to provide electrical interconnect between the modular lighting units.

11. The modular lighting unit according to claim 3, wherein said spring is formed by a washer, said washer having a peripheral part which is located farther away from the magnet than a centre of the washer.

12. The modular lighting unit according to claim 11, wherein the peripheral part of the washer is bent towards the magnet such that an outer peripheral edge is located on a level beneath a surface of the surrounding structure.

13. The modular lighting unit according to claim 11, wherein said washer comprises at least two incisions extending from a circumference of the washer towards a centre of the washer such that at least two wing like parts are formed.

14. The modular lighting unit according to claim 11, further comprising light elements disposed on said rear side of the modular lighting unit.
